(19) United States
(12) Patent Application Publication
(10) Pub. No.: US 2015/0124228 A1
(43) Pub. Date: May 7, 2015

(54) IMAGE PROJECTION APPARATUS AND IMAGE PROJECTION METHOD

(71) Applicant: LITE-ON IT CORPORATION, Taipei City (TW)

(72) Inventors: Chun-Po Hsu, Hsinchu (TW); Wen-Lung Lin, Hsinchu (TW); Chang-Feng Lee, Hsinchu (TW)

(73) Assignee: LITE-ON IT CORPORATION, Taipei City (TW)

(21) Appl. No.: 14/224,076

(22) Filed: Mar. 25, 2014

(30) Foreign Application Priority Data
Nov. 4, 2013 (CN) 201310537774.3

(51) Int. Cl. H04N 9/31; G03B 21/28

(52) U.S. Cl. CPC H04N 9/3135; G03B 21/28; G02B 26/105
USPC 353/98; 353/121

(57) ABSTRACT

An image projection apparatus and an image projection method are provided. The image projection apparatus includes a projection light source, a scanning module, a reflection mirror and an optical detector. The projection light source provides a projection light beam and the scanning module drives the projection light beam to scan along at least an axial direction. The reflection mirror is located on a scan path of the projection light beam. The optical detector detects the projection light beam reflected by the reflection mirror and generates synchronous signals. The image projection apparatus determines a scanning frequency of the projection light beam according to the synchronous signals.

### CROSS-REFERENCE TO RELATED APPLICATION

This application claims the priority benefit of China application Ser. No. 201310537774.3, filed on Nov. 4, 2013. The entirety of the above-mentioned patent application is hereby incorporated by reference herein and made a part of this specification.

### BACKGROUND OF THE INVENTION

1. Field of the Invention

The invention relates to an image projection apparatus and an image projection method, and particularly relates to an image projection apparatus and an image projection method capable of obtaining an oscillation frequency of a scanning module.

2. Description of Related Art

Micro-Electro-Mechanical System (MEMS) techniques generally refer to the research field of using micro-fabrication technologies to manufacture or develop electronic devices and mechanical structures, thereby miniaturizing relevant products. Since image projection apparatus using MEMS scanning module have the advantages of smaller sizes and lower power consumption, etc., such apparatus are developed to be implemented in portable electronic device such as smart phones and laptops in the near future.

Generally speaking, the MEMS scanning module of the image projection apparatus is used to project and drive a projection light beam to scan on a projection surface, so as to form an image. By controlling the MEMS scanning module to oscillate or vibrate with different pendulous axes as the axes, the projection light beam may be correspondingly projected on the projection surface and scan back and forth along the corresponding axis for projection. More specifically, by inputting a periodic wave having a specific frequency, the MEMS scanning module may respond to the specific frequency of the periodic wave by oscillating, such that a scanning frequency of the MEMS scanning module along a specific axial direction becomes controllable.

However, the amplitude of oscillation of the MEMS scanning module may be influenced by the temperature of the MEMS scanning module. Generally speaking, the amplitude of oscillation of the MEMS scanning module may become stabilized when the temperature of the MEMS scanning module reaches a certain level. In other words, when the temperature of the MEMS scanning module is lower than a certain level, the oscillation amplitude may vary, thereby influencing the size and quality of the projection image. Thus, it is important to monitor the actual oscillation frequency of the MEMS scanning module.

Usually, the skilled artisans use a piezoelectric material or a capacitor to monitor the actual oscillation frequency of the MEMS scanning module. However, since the MEMS scanning module is a microelement, using a piezoelectric material on the rotation axis of the MEMS scanning module is prone to influence the manufacturing process of the MEMS scanning module. Besides, using a capacitor to monitor the actual oscillation frequency of the MEMS scanning module only permits a very limited error, since it is prone to be interfered by other circuits or noises. Thus, how to detect the actual oscillation frequency of the MEMS scanning module without influencing the operation of the MEMS scanning module, thereby maintaining the stability of the projection image, is an issue that the skilled artisans need to work on.

### SUMMARY OF THE INVENTION

The invention provides an image projection apparatus that disposes a reflection mirror and detects a projection light beam reflected by the reflection minor to generate a plurality of synchronous signals. The image projection apparatus determines a scanning frequency of the projection light beam and adjusts a projection image according to the synchronous signals, thereby maintaining a quality of the projection image.

The invention provides an image projection method adapted for an image projection apparatus. The image projection method detects a projection light beam reflected by the reflection mirror to generate a plurality of synchronous signals, and determines a scanning frequency of the projection light beam and adjusts a projection image according to the synchronous signals, thereby maintaining a quality of the projection image.

The image projection apparatus includes a projection light source, a scanning module, a reflection minor, and an optical detector. The projection light source provides a projection light beam, and the scanning module drives the projection light beam to scan along at least an axial direction. The reflection minor is located on a scan path of the projection light beam. The optical detector detects the projection light beam reflected by the reflection minor and correspondingly generates a plurality of synchronous signals. The image projection apparatus determines a scanning frequency of the projection light beam according to the synchronous signals.

The image projection method of the invention is adapted for an image projection apparatus. The image projection apparatus includes a reflection mirror, and the reflection mirror is located on a scan path of the projection light beam. The image projection method includes the following steps. The projection light beam is provided, and the projection light beam is driven to scan along at least an axial direction. The projection light beam reflected by the reflection mirror is detected, and a plurality of synchronous signals are correspondingly generated. A scanning frequency of the projection light beam is determined according to the synchronous signals.

In view of the foregoing, the image projection apparatus and the image projection method according to the embodiments of the invention dispose the reflection mirror on the scan path of the projection light beam and detect the projection light beam reflected by the reflection mirror, so as to generate the plurality of synchronous signals. The image projection apparatus and the image projection method further make use of a generation frequency of the synchronous signals or a time interval between each of the synchronous signals to determine a scanning frequency of the projection light beam in a specific axial direction.

To make the above features and advantages of the invention more comprehensible, embodiments accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating an image projection apparatus according to an embodiment of the invention.

FIG. 2 is a schematic view illustrating a reflection minor according to an embodiment of the invention.

FIG. 3 is a schematic view illustrating synchronous signals according to an embodiment of the invention.

FIG. 4 is a flowchart illustrating an image projection method according to an embodiment of the invention.

### DESCRIPTION OF THE EMBODIMENTS

Descriptions of the invention are given with reference to the exemplary embodiments illustrated with accompanied drawings, wherein same or similar parts are denoted with same reference numerals. Moreover, elements/components/notations with same reference numerals represent same or similar parts in the drawings and embodiments.

In the present invention, an image projection apparatus with a scanning module and a reflection minor to indirectly detect the actual oscillation frequency of the scanning module in the specific axial direction is provided. According to the detected actual oscillation frequency of the scanning module, a scanning frequency of a projection light beam on a projection surface along the specific axial direction can be obtained to adjust a projection range of the projection light beam, thereby adjusting and maintaining a size and quality of the projection image.

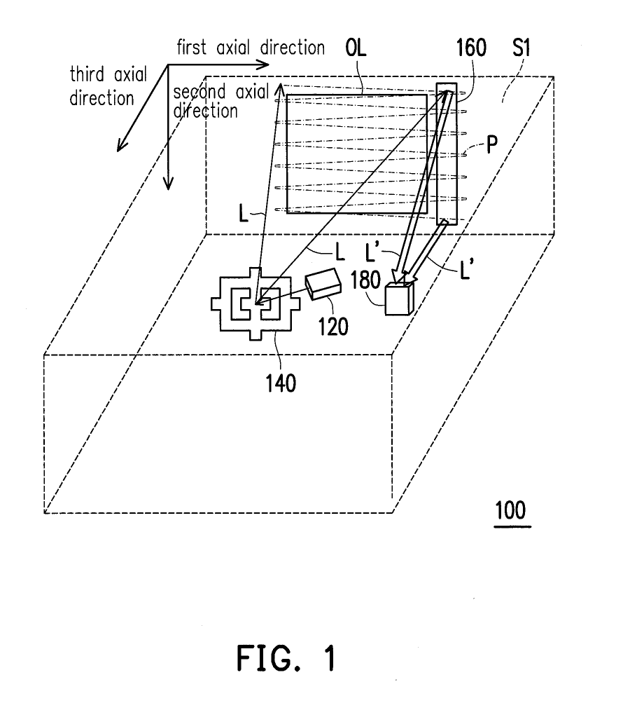

FIG. 1 is a schematic view illustrating an image projection apparatus according to an embodiment of the invention. Referring to FIG. 1, an image projection apparatus 100 includes a projection light source 120, a scanning module 140, a reflection mirror 160, and an optical detector 180. The projection light source 120 provides a projection light beam L, and the scanning module 140 drives the projection light beam L to scan back and forth and form a projection image (not shown). In addition, the projection light beam L is scanned back and forth along a first axial direction and a second axial direction based on the oscillation of the scanning module 140. In an embodiment, the scanning module 140 can be a MEMS scanning module. The reflection mirror 160 is disposed on one side of an outlet OL of the image projection apparatus 100 and is located on a scanning path P of the projection light beam L. The optical detector 180 detects a reflection light beam L′ reflected by the reflection mirror 160 and generates synchronous signals correspondingly. The image projection apparatus 100 determines the actual oscillation frequency of the scanning module 140 and a scanning frequency of the projection light beam L along the first axial direction based on the synchronous signals. The image projection apparatus 100 further generates a reference signal according to the synchronous signals generated by the optical detector 180 for controlling the timing of the image projection, so as to maintain stability of the projection image.

More specifically, the image projection apparatus 100 makes use of the oscillation (or vibration) of the scanning module 140 to drive the projection light beam L to project to a plural of projection positions along the scan path P, so as to form the projection image. The projection light beam L is a coaxial projection light beam formed of red, green, and blue image beams, for example. The projection light source 120 is controlled to emit the projection light beam L with related image data corresponding to the related projection position. When the scanning module 140 oscillates back and forth along a specific axial direction, it takes the projection light beam L to scan back and forth along the same or a corresponding specific axial direction, similar to generating a plurality of scanning lines. More specifically, as shown in FIG. 1, with the scanning module 140 oscillating in a plurality of specific axial directions, the projection light beam L is allowed to scan simultaneously along the first axial direction and the second axial direction. The projection image (i.e. an image) is thereby generated due to vision persistence of human eyes. In FIG. 1, the projection light beam L scans faster in the first axial direction but slower in the second axial direction, so a scan path P as shown in FIG. 1 is formed. When the projection light beam L scans from a first end of the second axial direction (i.e. a starting point of projection in the second axial direction) to a second end (i.e. an end point of projection in the second axial direction), projection of a frame of a projection image is finished. However, the invention does not limit the scan path P of the projection light beam L, and the scan path P in FIG. 1 may be adjusted according to actual practice of the image projection apparatus 100. Besides, when the projection light beam L completely finishes projection of a frame of a projection image (i.e. finishing running through the scan path P), the projection light beam L is then projected for the next frame of the projection image by making use of the scanning module 140.

In this embodiment, the projection light beam L passes through the outlet OL to the projection surface with assistance of the scanning module 140 and scans along the scan path P to form the projection image. The reflection mirror 160 is disposed at one side of the outlet OL, and is disposed along the second axial direction and perpendicular to the first axial direction. However, the invention does not limit manners of disposition of the reflection mirror. In other embodiments, the reflection mirror 160 may be correspondingly disposed according to the scan path P of the projection light beam L. During scanning of the projection light beam L along the first axial direction, the reflection mirror 160 reflects the projection light beam L when the projection light beam L is scanned on and projected to the reflection mirror 160, and the reflection light beam L′ after reflection is received by the optical detector 180. More specifically, the reflection mirror 160 is disposed within a boundary of the scan path P of the projection light beam L. As shown in FIG. 1, a coverage of the scan path P is larger than a coverage of the outlet OL, and the coverage of the scan path P covers both the outlet OL and the reflection mirror 160. The reflection mirror 160 is located within a scanning boundary of the scan path P in the first axial direction. The scan path P crosses the reflection mirror 160 for a plurality of times, indicating that the projection light beam L is scanned on and projected to the reflection mirror 160 for a plurality of times, and the reflection mirror 160 then reflects the projection light beam L to the optical detector 180 corresponding to each time that the projection light beam L is scanned on and projected to the reflection mirror 160.

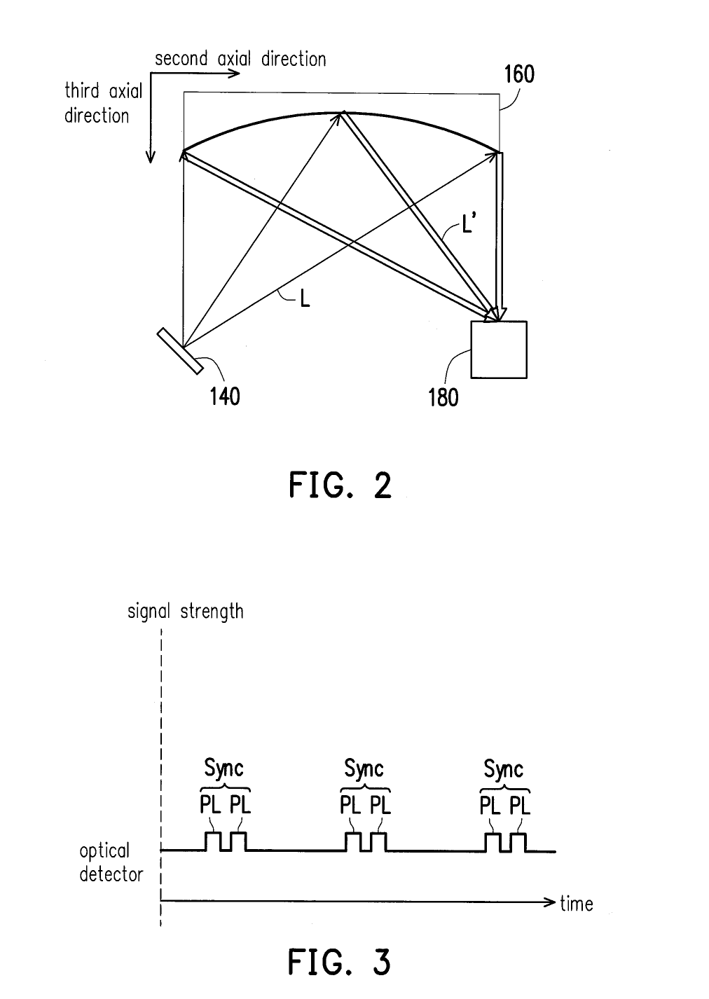

With the reflection mirror design, all of the light beams projected to the reflection mirror 160 are reflected to the optical detector 180. FIG. 2 is a schematic view illustrating a reflection mirror according to an embodiment of the invention. As shown in FIG. 2, the reflection mirror 160 may be a designed concave mirror, wherein the concave of the reflection mirror 160 receives the projection light beam L and faces the optical detector 180. During vibration of the scanning module 140, the reflection mirror 160 reflects the projection light beam L projected thereon, and the reflection light beam L′ after reflection is received by the optical detector 180. In this embodiment, an area between the reflection mirror 160 and the outlet OL may be an blackened area (not shown), so as to prevent the reflection light beam L′ reflected by the reflection mirror 160 from being further reflected or refracted by the image projection apparatus 100 to influence a quality of image formation. In another embodiment, an apparatus internal surface Si in the same side that the reflection mirror 160 disposed may be completely blackened.

FIG. 3 is a schematic view illustrating synchronous signals according to an embodiment of the invention. Referring to FIGS. 1 and 3, when the optical detector 180 receives the reflection light beam reflected by the reflection mirror 160, the optical detector 180 correspondingly generates a pulse signal PL, and each of synchronous signals Sync further includes at least two of the pulse signals PL. In this embodiment, the reflection mirror 160 is located near the scanning boundary of the scan path P in the first axial direction. Due to the scanning module 140 oscillating back and forth, the projection light beam L changes the scan direction when reaching the scanning boundary of the scan path P in the first axial direction. Accordingly, the projection light beam L is projected to the reflection mirror 160 twice in a short period of time. The reflection light beam L′ reflected by the reflection mirror 160 is then received by the optical detector 180 and generates at least two of the pulse signals PL in a short period of time, as shown in FIG. 3. One set of the pulse signals PL may be considered as one of the synchronous signals Sync for indicating ending of a scanning line (in the first axial direction) and beginning of the next scanning line (in the first axial direction).

The image projection apparatus 100 then determines an actual oscillation frequency of the scanning module 140 and a scanning frequency of the projection light beam L along the first axial direction based on a generation frequency of the synchronous signals Sync (i.e. a time interval between a plurality of synchronous signals Sync). In an embodiment, the image projection apparatus 100 further serves the synchronous signals Sync as a reference signal for controlling the image projection timing, so as to maintain the projection image and projection quality. More specifically, as shown in FIG. 1, the synchronous signal Sync serves to indicate ending of a scanning line and beginning of the next scanning line. According to the beginning of each scanning line, the image projection apparatus 100 controls the start timing of the projection image corresponding to the related scanning line. In other words, a time interval between the synchronous signals Sync indicates time taken for the scanning module 140 to drive the projection light beam L to complete one scanning line process along the first axial direction. When the image projection apparatus 100 detects that the time interval between the synchronous signals Sync is different from expectation, it is indicated that an actual oscillation frequency of the scanning module 140 in a specific axial direction may be erroneous, so the generation frequency of the synchronous signals Sync is changed. Thus, the image projection apparatus 100 may utilize the synchronous signals Sync as a reference starting point of the projection image to correct jittering of the starting point due to temperature.

In this embodiment, analyzing of the synchronous signals Sync and operating of the projection light source 120 or the scanning module 140 may be handled by a control unit (not shown) in the image projection apparatus 100 or another hardware or firmware apparatus adapted for analysis and control, so no further details in this respect will be described hereinafter.

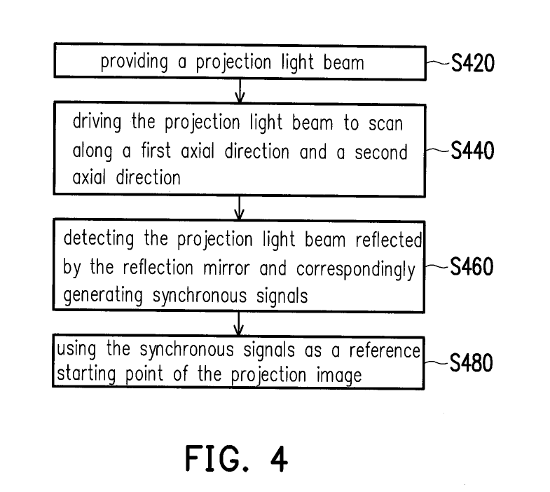

FIG. 4 is a flowchart illustrating an image projection method according to an embodiment of the invention. Referring to FIG. 4, the image projection method is suitable for an image projection apparatus to obtain an oscillation frequency of a scanning module and maintains stability of a projection image. The image projection apparatus includes a reflection minor that is disposed on one side of an outlet of the image projection apparatus and located on a scan path of a projection light beam. The image projection method includes the following. At Step S420, the projection light beam is provided. In addition, at Step S440, the projection light beam is driven to scan along a first axial direction and a second axial direction. During scanning of the projection light beam along the first axial direction, the reflection mirror reflects the projection light beam when the image light beam is projected to the reflection minor. Then, at Step 5460, the image light beam reflected by the reflection mirror is detected, and synchronous signals are correspondingly generated. Generating the synchronous signals further includes receiving the projection light beam reflected by the reflection minor and correspondingly generating a pulse signal. In an embodiment, each of the synchronous signals further includes at least two of the pulse signals. Lastly, at Step S480, the synchronous signals is used as a reference starting point of the projection image to correct uttering of a starting point of the projection image. In another embodiment, an actual oscillation frequency of a scanning module and/or a scanning frequency of the projection light beam along a specific axial direction is obtained based on the synchronous signals.

In view of the foregoing, in the image projection apparatus and image projection method provided in the invention, the reflection mirror is disposed to reflect the projection light beam, and the optical detector receives the projection light beam after reflection to generate the plurality of synchronous signals. The image projection apparatus and the image projection method determines the scanning frequency of the projection light beam along a specific axial direction according to the synchronous signals, and using the synchronous signals as the reference starting point of the projection image, so as to adjust and maintain the quality of the projection image.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An image projection apparatus with a scanning frequency detecting function, the image projection apparatus comprises:
a projection light source, providing a projection light beam;
a scanning module, driving the projection light beam to scan along at least an axial direction;
a reflection mirror, located on a scan path of the projection light beam; and
an optical detector, detecting the projection light beam reflected by the reflection mirror and correspondingly generating synchronous signals,
wherein the image projection apparatus determines a scanning frequency of the projection light beam according to the synchronous signals.

2. The image projection apparatus as claimed in claim 1, wherein the synchronous signals is used as a reference starting point of a projection image.

3. The image projection apparatus as claimed in claim 1, wherein the optical detector correspondingly generates a pulse signal when the optical detector receives the projection light beam reflected by the reflection mirror, and each of the synchronous signals comprises at least two of the pulse signals.

4. The image projection apparatus as claimed in claim 1, wherein the image projection apparatus determines the scanning frequency of the projection light beam along the axial direction based on a generation frequency of the synchronous signals.

5. The image projection apparatus as claimed in claim 1, wherein an area between the reflection mirror and the outlet is a blackened area.

6. An image projection method, adapted for an image projection apparatus, wherein the image projection apparatus comprises a reflection mirror located on a scan path of a projection light beam of the image projection apparatus, the image projection method comprising:
providing the projection light beam;
driving the projection light beam to scan along at least an axial direction;
detecting the projection light beam reflected by the reflection mirror and correspondingly generating synchronous signals; and
determining a scanning frequency of the projection light beam according to the synchronous signals.

7. The image projection method as claimed in claim 6, wherein the image projection method further comprises step of using the synchronous signals as a reference starting point of a projection image.

8. The image projection method as claimed in claim 6, wherein detecting the projection light beam reflected by the reflection mirror and correspondingly generating the synchronous signals further comprise:
receiving the projection light beam reflected by the reflection mirror and correspondingly generating a pulse signal, wherein each of the synchronous signals comprises at least two of the pulse signals.

9. The image projection method as claimed in claim 6, wherein determining the scanning frequency of the projection light beam according to the synchronous signals further comprises:
determining the projection frequency of the projection light beam along the axial direction based on a generation frequency of the synchronous signals.
